(19) United States
(12) Patent Application Publication
(10) Pub. No.: US 2026/0195997 A1
(43) Pub. Date: Jul. 9, 2026

(54) PROCESSABILITY DETERMINATION DEVICE, PROCESSABILITY LEARNING DEVICE, PROCESSABILITY DETERMINATION METHOD, PROCESSABILITY LEARNING METHOD, MEDIUM STORING PROCESSABILITY DETERMINATION PROGRAM, AND MEDIUM STORING PROCESSABILITY LEARNING PROGRAM

(71) Applicant: Mitsubishi Electric Corporation, TOKYO (JP)

(72) Inventor: Atsuyoshi YANO, TOKYO (JP)

(73) Assignee: Mitsubishi Electric Corporation, TOKYO (JP)

(21) Appl. No.: 19/557,644

(22) Filed: Mar. 5, 2026

Related U.S. Application Data
(63) Continuation of application No. PCT/JP2023/035118, filed on Sep. 27, 2023.

(51) Int. Cl. G06T 19/00; G06N 20/00; G06T 7/50

(52) U.S. Cl. CPC G06T 19/00; G06N 20/00; G06T 7/50

(57) ABSTRACT

A processability determination device includes a three-dimensional shape extraction unit, a three-dimensional shape rotation unit, a depth map transformation unit, and an inference model that is constructed by machine learning by use of a learning processing axis direction instruction, a learning depth map extracted from learning three-dimensional shape data, and processability information describing propriety of actual processing already performed according to the learning processing axis direction instruction and the learning three-dimensional shape data, and determines the propriety of processing of the processing plan shape by inference by use of the desired processing axis and the depth map generated by the depth map transformation unit.

### CROSS-REFERENCE TO RELATED APPLICATION

This application is a continuation application of International Application No. PCT/JP2023/035118 having an international filing date of September 27, 2023, which is hereby expressly incorporated by reference into the present application.

### BACKGROUND OF THE INVENTION

### Field of the Invention

The present disclosure relates to a processability determination device, a processability learning device, a processability determination method, a processability learning method, a processability determination program, and a processability learning program.

### Description of the Related Art

In cutting processing for cutting a material (processing target object) by using a cutting tool (hereinafter abbreviated as a "tool") such as a drill, a milling cutter or a tool bit, there are cases where the cutting by using the tool is difficult depending on the shape in the design. Further, there can occur expansion of the material or deformation of the tool due to heat generated at the time of the processing, and there can also occur a processing defect due to vibration or deflection of the tool.

Patent Reference 1 discloses an electrode manufacturing method in which propriety of electrode manufacture by means of electrical discharge machining is determined. Further, Non-patent Reference 1 discloses a technology of determining the propriety of the cutting possibility by using a device trained by inputting Voxel data representing a three-dimensional shape to a 3D-CNN (three-dimensional convolutional neural network) model.

Patent Reference 1: Japanese Patent Application Publication No. 2010-105080.

Non-patent Reference 1: Sambit Ghadai and 3 others, “Learning localized features in 3D CAD models for manufacturability analysis of drilled holes”, Computer Aided Geometric Design 62 (2018), pp. 263-275.

However, in the technology described in the Patent Reference 1, all ridge lines forming the electrode shape are extracted from inputted three-dimensional electrode data and shape identification information and the determination of the propriety of the processing is made for the contour of the electrode identified from the extracted ridge lines, and thus there is a problem in that the computational load for extracting the contour of the electrode from the three-dimensional electrode data and the like increases. Further, the technology described in the Non-patent Reference 1 requires a large-scale 3D-CNN model in order to handle the Voxel data being three-dimensional data, and thus has a problem in that the computational load and the number of pieces of data necessary for learning increase.

### SUMMARY OF THE INVENTION

An object of the present disclosure is to provide a processability determination device, a processability determination method and a processability determination program for determining the propriety of cutting processing (whether the cutting processing is possible or impossible), and a processability learning device, a processability learning method and a processability learning program for constructing the processability determination device by means of learning in which the number of pieces of learning data and the computational load are restrained.

A processability determination device in the present disclosure includes processing circuitry to extract a three-dimensional shape from three-dimensional shape data representing a processing plan shape; to rotate the three-dimensional shape so that a processing surface in the three-dimensional shape faces a desired processing axis direction; and to generate a depth map in which information on depth in the desired processing axis direction extracted from the three-dimensional shape data is attached to a two-dimensional image obtained by orthographically projecting the processing surface onto a plane orthogonal to the desired processing axis direction; and an inference model that is constructed by machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the generated depth map.

A processability determination method to be executed by a computer, in the present disclosure, includes extracting a three-dimensional shape from three-dimensional shape data representing a processing plan shape; rotating the three-dimensional shape so that a processing surface in the three-dimensional shape faces a desired processing axis direction; generating a depth map in which information on depth in the desired processing axis direction extracted from the three-dimensional shape data is attached to a two-dimensional image obtained by orthographically projecting the processing surface onto a plane orthogonal to the desired processing axis direction; and performing machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the depth map.

A processability determination program in the present disclosure includes, the processability determination program causing a computer to execute:

A processability determination program that causes a computer to execute: extracting a three-dimensional shape from three-dimensional shape data representing a processing plan shape; rotating the three-dimensional shape so that a processing surface in the three-dimensional shape faces a desired processing axis direction; generating a depth map in which information on depth in the desired processing axis direction extracted from the three-dimensional shape data is attached to a two-dimensional image obtained by orthographically projecting the processing surface onto a plane orthogonal to the desired processing axis direction; and performing machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the depth map.

According to the present disclosure, it becomes possible to provide a processability determination device, a processability determination method and a processability determination program that determine the propriety of the cutting processing by means of learning in which the number of pieces of the learning data and the computational load are restrained by using a depth map from a processing axis direction, while also providing a processability learning device, a processability learning method and a processability learning program that execute the learning.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1a is a functional configuration diagram showing a processability determination device according to a first embodiment, and

FIG. 1b is a functional configuration diagram showing a processability learning device according to the first embodiment;

FIG. 2 is a hardware configuration diagram showing the processability determination device and the processability learning device according to the first embodiment;

FIGS. 3a, 3b and 3c are explanatory diagrams illustrating cutting processing by a cutting processing machine such as a milling machine or a machining center;

FIGS. 4a, 4b, 4c, 4d and 4e are explanatory diagrams illustrating cases where processing is not possible;

FIG. 5 is a flowchart showing an example of a determination process of the trained processability determination device according to the first embodiment;

FIG. 6a is a schematic diagram showing an example of a three-dimensional shape extracted from three-dimensional CAD data, and

FIG. 6b shows an example of a depth map generated from the three-dimensional shape shown in FIG. 6a;

FIG. 7a is a schematic diagram showing an example of a case where a tool accesses a material in a processing axis direction, and

FIG. 7b is an explanatory diagram indicating that shape information on a processing surface can be represented by a depth map by means of orthographic projection;

FIG. 8 is a functional configuration diagram showing a processability determination device according to a second embodiment;

FIG. 9a is an explanatory diagram illustrating a part where cutting is difficult in the present processing axis direction, and

FIG. 9b is an explanatory diagram showing a case where processing becomes possible by changing the processing axis direction;

FIG. 10 is a flowchart showing an example of a determination process of the trained processability determination device according to the second embodiment;

FIG. 11a is a functional configuration diagram showing a processability determination device according to a third embodiment, and

FIG. 11b is a functional configuration diagram showing a processability learning device according to the third embodiment;

FIG. 12 is a functional configuration diagram showing a processability learning device according to a fourth embodiment;

FIG. 13a is a schematic diagram showing an example of a depth map, and

FIG. 13b is a schematic diagram showing an example of a heat map showing a processing inadequate part as processability information corresponding to the depth map in FIG. 13a;

FIG. 14 is a functional configuration diagram showing a processability determination device according to a fifth embodiment;

FIG. 15a is an explanatory diagram showing a processing plan shape for a material shape,

FIG. 15b is an explanatory diagram of a case where a processing surface-processing axis direction recording unit records the processing axis directions in a processing surface list generated by a processing surface dividing unit,

FIG. 15c is an explanatory diagram of a case where the material shape shown in FIG. 15a is rotated 90° to the left in the drawing by a three-dimensional shape rotation unit, and

FIG. 15d is an explanatory diagram of a case where the processing surface-processing axis direction recording unit records the processing axis directions in the processing surface list in the state in which the material shape is rotated 90°; and

FIG. 16 is a flowchart showing an example of a determination process of the trained processability determination device according to the fifth embodiment.

### DETAILED DESCRIPTION OF THE INVENTION

A processability determination device and a processability learning device according to each embodiment will be described below with reference to the drawings. The following embodiments are just examples and it is possible to appropriately combine embodiments and appropriately modify each embodiment.

### First Embodiment

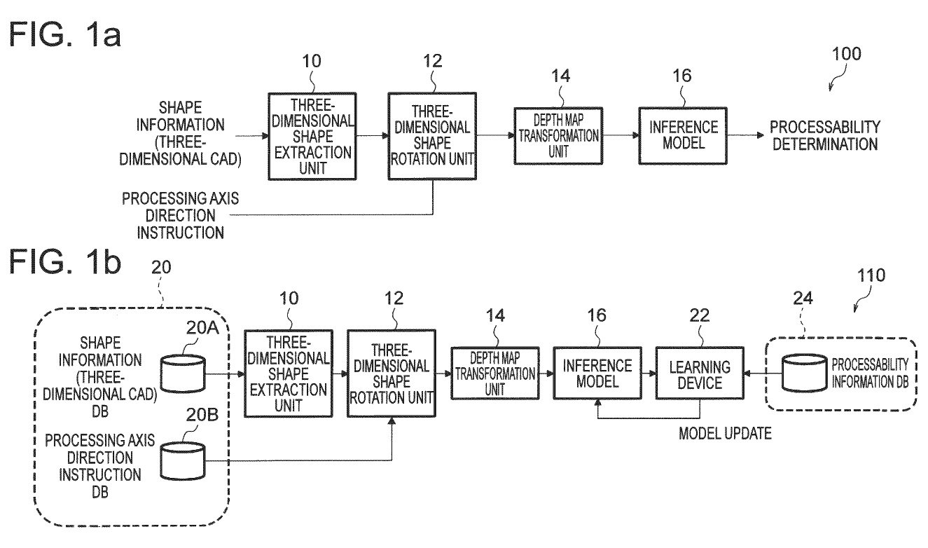

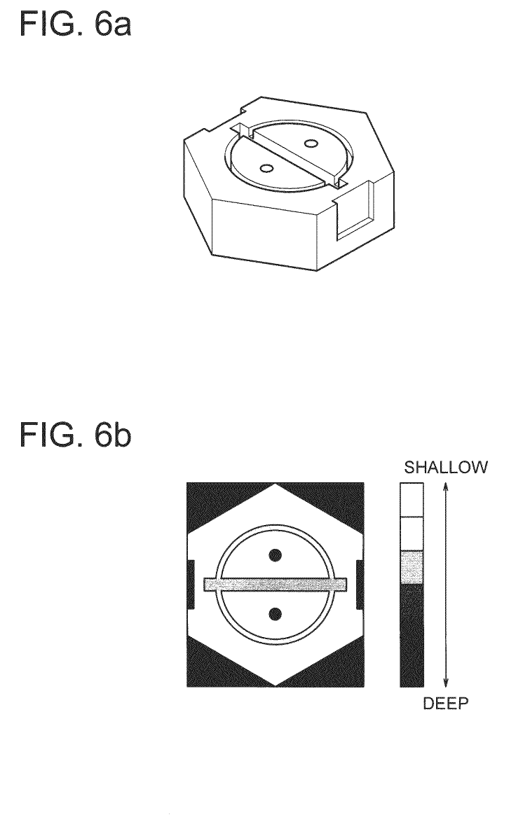

FIG. 1a is a functional configuration diagram showing a processability determination device 100 according to a first embodiment. The processability determination device 100 includes a three-dimensional shape extraction unit 10 that extracts information on the shape of a material as a processing object after the processing (processing plan shape) from inputted three-dimensional CAD data, a three-dimensional shape rotation unit 12 that orients a surface to be processed (hereinafter referred to as a "processing surface") in the extracted shape information in a desired processing axis direction (e.g., Z-axis direction) based on an inputted processing axis instruction, a depth map transformation unit 14 that generates a depth map regarding the processing axis direction as shown in FIG. 6b by transforming the shape information in which the processing surface is oriented in the processing axis direction, and an inference model 16 that determines whether processing is possible or not regarding the generated depth map and outputs a result of the determination. As will be described later, the inference model 16 is constructed by training a mathematical model such as CNN by machine learning using learning processing axis direction instructions, learning depth maps extracted from learning three-dimensional shape data according to the learning processing axis direction instructions, and processability information describing the propriety of actual processing already performed according to the learning processing axis direction instruction and the learning three-dimensional shape data, that have previously been prepared for the learning.

FIG. 1b is a functional configuration diagram showing a processability learning device 110 according to the first embodiment. The processability learning device 110 includes a shape-processing axis direction database (DB) 20, a processability information DB 24 storing the processability information as training data, and a learning device 22 that updates the inference model 16 with the processability information, in addition to the three-dimensional shape extraction unit 10, the three-dimensional shape rotation unit 12, the depth map transformation unit 14 and the inference model 16 described earlier.

The shape-processing axis direction DB 20 includes a shape information DB 20A storing three-dimensional CAD data as the learning three-dimensional shape data and a processing axis direction instruction DB 20B storing instructions of processing axis directions as the learning processing axis direction instructions.

Data stored in each of the shape information DB 20A, the processing axis direction instruction DB 20B and the processability information DB 24 are past processing case data. For example, the three-dimensional CAD data stored in the shape information DB 20A are learning data of three-dimensional shapes actually used in processing, and the instructions of the processing axis directions stored in the processing axis direction instruction DB 20B are also learning data of processing axis direction instructions actually used in processing. Further, the processability information DB 24 stores propriety of a result of the processing by use of the three-dimensional CAD data stored in the shape information DB 20A and the instructions of the processing axis directions stored in the processing axis direction instruction DB 20B. Further, the processability information for learning stored in the processability information DB 24 corresponds to each of the three-dimensional CAD data stored in the shape information DB 20A and the processing axis direction instructions stored in the processing axis direction instruction DB 20B. In the first embodiment, the learning device 22 evaluates the inference model 16 by comparing the result of judging the learning depth map, obtained by using each of the three-dimensional CAD data and the processing axis direction instructions as the past processing case example data, by using the inference model 16 with the processability information corresponding to the three-dimensional CAD data and the processing axis direction instruction used by the inference model 16 for the judgment, and updates the inference model 16.

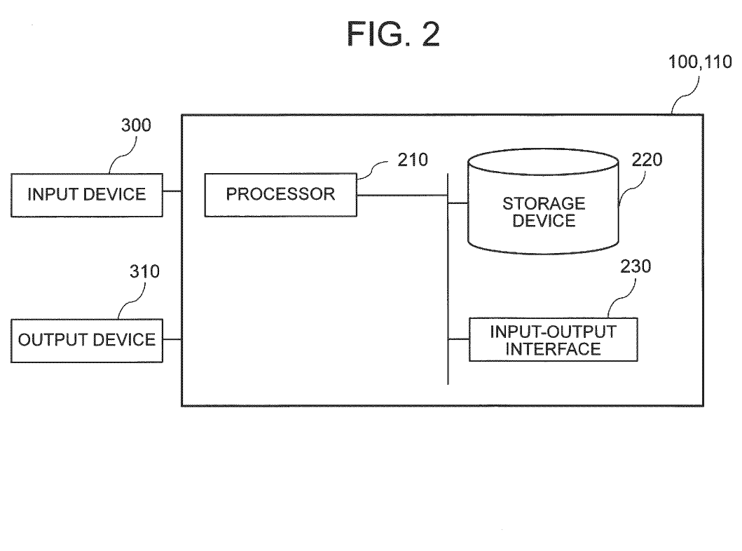

FIG. 2 is a hardware configuration diagram showing the processability determination device 100 and the processability learning device 110 according to the first embodiment. Each of the processability determination device 100 and the processability learning device 110 is configured by a computer including a processor 210, a storage device 220 and an input-output interface 230. The processability determination device 100 may be configured by a plurality of computers.

The processor 210 is an IC (Integrated Circuit) that executes arithmetic processing. As a concrete example, the processor 210 is a CPU (Central Processing Unit), a DSP (Digital Signal Processor), a GPU (Graphics Processing Unit) or the like. The processor 210 is capable of rendering three-dimensional CAD data, is capable of changing the direction of the imaged three-dimensional CAD data to an arbitrary processing axis direction, and functions as the three-dimensional shape extraction unit 10, the three-dimensional shape rotation unit 12 and the depth map transformation unit 14 described above by running a program that generates the depth map from the three-dimensional CAD data. Further, the processor 210 functions as the aforementioned learning device 22 by running a program that performs machine learning by use of training data, and as the result of the machine learning, constructs the inference model 16 that determines the processability. In the first embodiment, by the operation of a processability learning program regarding the machine learning, the processor 210 functions as the three-dimensional shape extraction unit 10, the three-dimensional shape rotation unit 12, the depth map transformation unit 14, and the learning device 22 that updates the inference model 16. Further, in the first embodiment, after the machine learning, by the operation of a processability determination program, the processor 210 functions as the three-dimensional shape extraction unit 10, the three-dimensional shape rotation unit 12, the depth map transformation unit 14 and the inference model 16. Furthermore, the processability determination program and the processability learning program are provided through a record medium that has recorded these programs, for example.

Functions of the processability determination device 100 are implemented by processing circuitry, which can be either dedicated hardware or the processor 210 executing a program stored in the memory as a storage device (i.e., record medium) 220. Further, functions of the processability learning device 110 are implemented by processing circuitry, which can be either dedicated hardware or the processor 210 executing a program stored in the memory as a storage device (i.e., record medium) 220.

The storage device may be a non-transitory computer-readable storage medium, namely, a non-transitory tangible storage medium storing a program such as the processability determination program or the processability learning program. The processor 210 can be any one of a processing device, an arithmetic device, a microprocessor, a microcomputer and a DSP.

The storage device 220 is configured by a volatile storage device such as a RAM (Random Access Memory) or a nonvolatile storage device such as a ROM (Read Only Memory), an HDD (Hard Disk Drive) or a flash memory.

The input-output interface 230 is a port to which an input device 300 and an output device 310 are connected. As a concrete example, the input-output interface 230 is a USB (Universal Serial Bus) terminal, an IEEE 1394 terminal, a Thunderbolt terminal or the like, and further includes a communication interface for Ethernet or the like. The input device 300 is a touch panel, a keyboard, a mouse or the like. The output device 310 is a display, a printer or the like. At the time of learning, each of the shape-processing axis direction DB 20 and the processability information DB 24 is connected to the above-described input-output interface 230. Each of the shape-processing axis direction DB 20 and the processability information DB 24 may be constructed in the storage device 220.

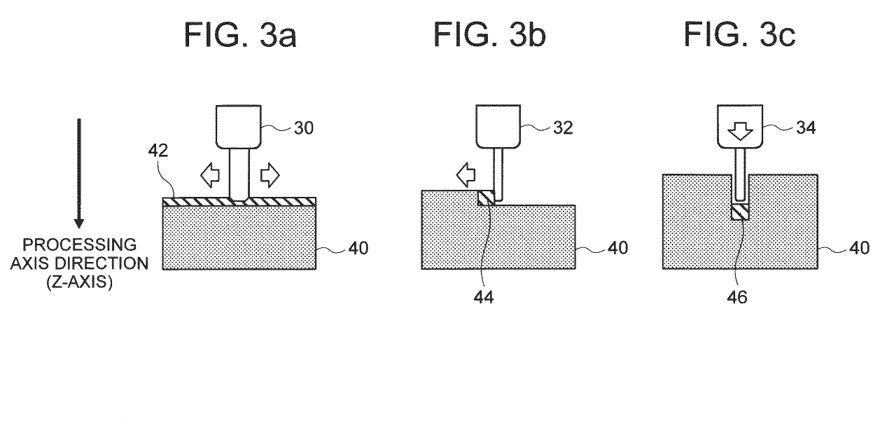

FIGS. 3a, 3b and 3c are explanatory diagrams illustrating the cutting processing by a cutting processing machine such as a milling machine or a machining center. FIG. 3a is an explanatory diagram showing planar machining of cutting a planar cutting surface 42 of a material (e.g., a workpiece) 40 with a tool 30 such as a plain milling cutter. In the planar machining, on a plane of the material 40 that is orthogonal to the processing axis direction, the cutting surface 42 is cut with the tool 30 moving in a direction parallel to the plane as indicated by the arrows.

FIG. 3b is an explanatory diagram showing side face machining of cutting a side face of the material 40 with a tool 32 such as an angle milling cutter. In side face cutting, a cutting surface 44 is cut with the tool 32 moving in the direction of the arrow.

FIG. 3C is an explanatory diagram showing drilling and pocket machining of cutting the material 40 in the processing axis direction with a tool 34 such as an end mill. In the drilling and pocket machining, a cutting surface 46 of the material 40 is cut with the tool 34 fed in the processing axis direction indicated by the arrow.

In the first embodiment, the propriety of processing other than the above-described processing is also determined. For example, it is also possible to determine feasibility of processing in regard to the formation of a three-dimensional shape by means of electrical discharge processing of processing the material by arc discharge between an electrode and the material.

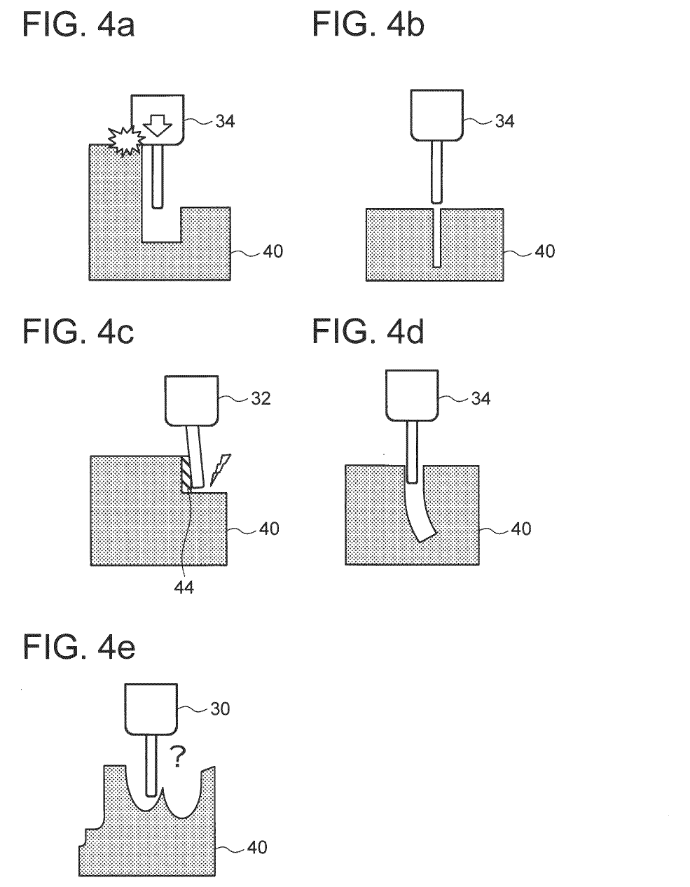

FIGS. 4a, 4b, 4c, 4d and 4e are explanatory diagrams illustrating cases where processing is not possible. FIG. 4a shows a case of tool interference in which a part of the tool 34 other than a cutting edge interferes with the material 40, and FIG. 4b shows a case where the tool 34 is not suitable for the processing shape of the material 40. In the cases shown in FIGS. 4a and 4b, the problems can be solved according to rules in the processing such as changing the tool 34 to a tool suitable for the situation, and thus it is possible to judge the processability even without using the processability determination device 100 according to the first embodiment.

FIG. 4c shows a case where it becomes impossible to precisely cut the cutting surface 44 due to vibration of the tool 32 or the like, and FIG. 4d shows a case where the tool 34 bends and the material 40 cannot be cut correctly. FIG. 4e shows a case where the processing shape of the material 40 is complicated and it is difficult to make the judgment based on the rules in the processing. In the cases shown in FIGS. 4c, 4d and 4e, it is impossible to solve the problems based on the rules in the processing such as changing the tool, and thus a skilled person has conventionally judged the propriety of the processing based on their own experience. In the first embodiment, the propriety of the processing in cases like those shown in FIGS. 4c, 4d and 4e is determined by the trained processability determination device 100, without relying on the skilled person.

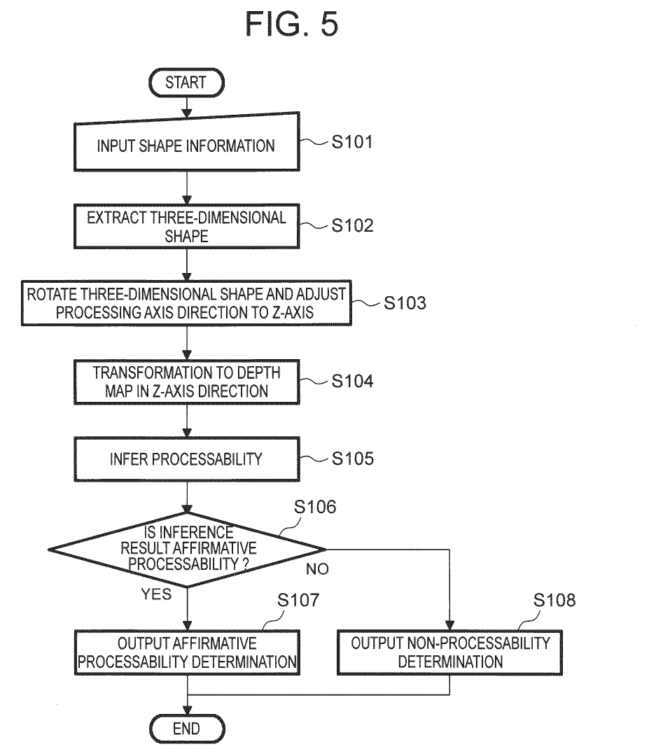

FIG. 5 is a flowchart showing an example of a determination process of the trained processability determination device 100 according to the first embodiment. In step S101, the three-dimensional CAD data as the shape information is inputted to the three-dimensional shape extraction unit 10.

In step S102, the three-dimensional shape extraction unit 10 extracts the three-dimensional shape by rendering the inputted three-dimensional CAD data. FIG. 6a is a schematic diagram showing an example of the three-dimensional shape extracted from the three-dimensional CAD data.

In step S103, the three-dimensional shape rotation unit 12 rotates the three-dimensional shape extracted in the step S102 according to the processing axis direction instruction. In the first embodiment, the processing surface of the material 40 is oriented in the Z-axis direction as an example. More specifically, the processing surface of the material 40 is placed to face (e.g., to directly face, or to squarely face) the Z-axis direction. That is, the processing surface of the material 40 is placed to face directly along the Z-axis. The processing axis direction instruction may be either previously set at the Z-axis or inputted at the stage of the step S101.

In step S104, the depth map transformation unit 14 generates a depth map of the three-dimensional shape whose processing surface is oriented in the Z-axis direction. FIG. 6b shows an example of the depth map generated from the three-dimensional shape shown in FIG. 6a. The depth map is two-dimensional image data generated by orthographic projection of the three-dimensional shape whose processing surface is oriented in the Z-axis direction onto a plane orthogonal to the Z-axis. In the depth map, information on the depth in the Z-axis direction is attached to data of a two-dimensional image representing the processing surface. The information on the depth in the Z-axis direction is extracted from the three-dimensional CAD data as the inputted shape information. In FIG. 6b, the information on the depth is hue or lightness. In the depth map, a shallow part is represented by bright hue such as yellow color, and a deep part is represented by dark hue such as dark blue color. When the depth is represented using a single color such as gray, a shallow part is represented with high brightness, and a deep part is represented with low brightness.

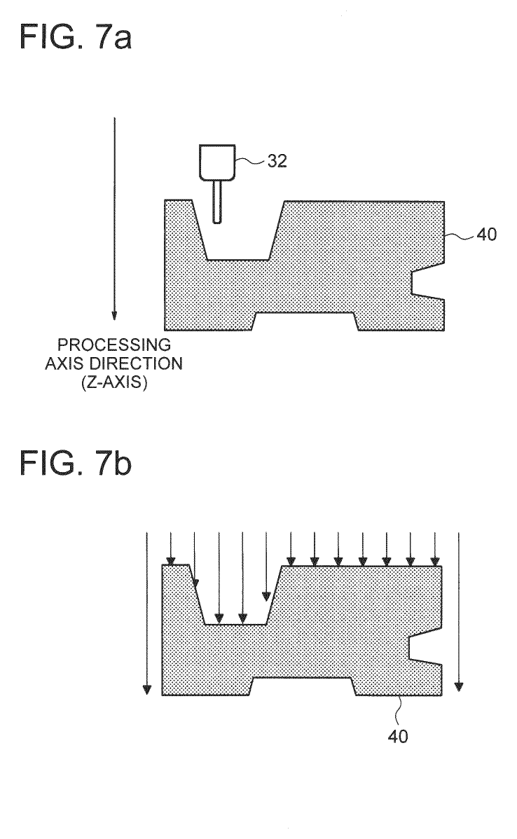

In a cutting processing machine such as a milling machine, the tool 32 approaches the material 40 in the processing axis direction (the Z-axis direction) to perform processing, as shown in FIG. 7a, and thus, as information necessary for determining processability, the shape information of the processing surface as viewed in the Z-axis direction is important, whereas the shape information of the side or back surfaces of the material 40, other than the processing surface, is unnecessary for the present. Since the shape information on the processing surface can be represented by the depth map by means of the orthographic projection as indicated by the arrows in FIG. 7b, the processability can be determined using the depth map being two-dimensional data instead of data representing the three-dimensional shape.

In step S105, the inference model 16 infers the processability. As mentioned earlier, in the first embodiment, the inference model 16 is trained using the three-dimensional CAD data, the processing axis direction instructions, and the processability information corresponding to each of the three-dimensional CAD data and the processing axis direction instructions. The trained inference model 16 performs inference based on the propriety of the processing in the processability information used for the learning, and outputs a result of the inference.

In step S106, the inference model 16 determines whether the result of the inference outputted in the step S105 indicates that processing is possible or not. The process is advanced to step S107 if the result of the determination in the step S106 indicates that processing is possible, or the process is advanced to step S108 if the result of the determination in step S106 indicates that processing is not possible.

In the step S107, the inference model 16 outputs an affirmative processability determination to the output device 310 and ends the process. In the step S108, the inference model 16 outputs a non-processability determination to the output device 310 and ends the process.

As described above, in the first embodiment, the propriety of the processing is determined by using the depth map as two-dimensional data generated from the three-dimensional shape. Preparing the data as two-dimensional data reduces the data size as compared with the three-dimensional shape, by which the number of pieces of learning data and the computational load at the time of the learning of the inference model 16 can be restrained. Further, the computational load for the processability determination on the trained processability determination device 100 can be restrained.

When implementing the inference model 16 for the processability determination of cutting processing, a model to which Voxel data are inputted as in the conventional technology needs to handle data representing the three-dimensional shape and thus requires a great amount of computation and a great amount of learning data. However, in the first embodiment, the amount of computation and the learning data can be reduced by inputting the depth map being two-dimensional data to the model. Further, if the number of pieces of learning data is the same, it becomes possible to realize higher determination accuracy as compared with the conventional technology since the number of parameters of the neural network is smaller.

### Second Embodiment

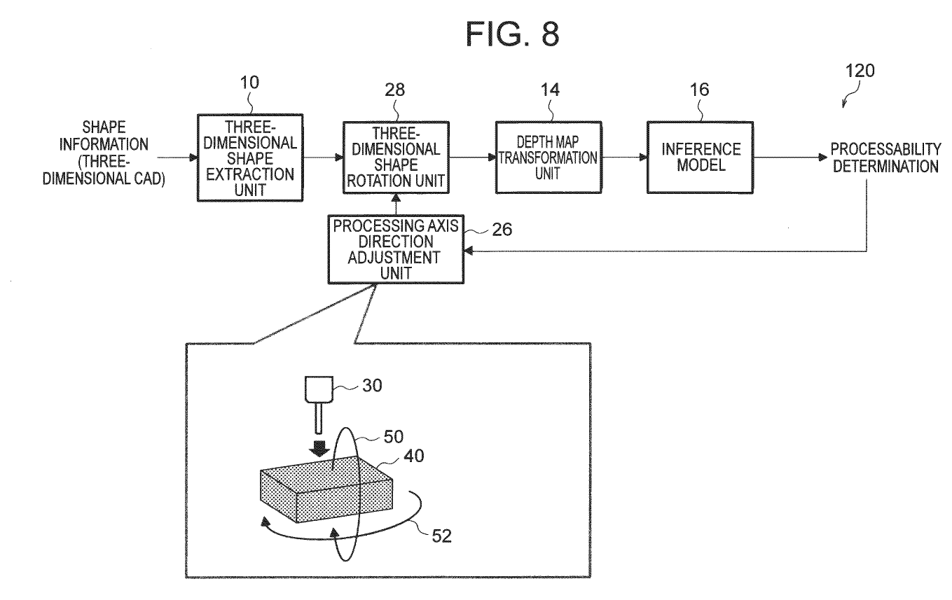

Next, a processability determination device 120 according to a second embodiment will be described below. The processability determination device 120 according to the second embodiment shown in FIG. 8 differs from the device in the first embodiment in that the processability determination device 120 includes a processing axis direction adjustment unit 26 that adjusts the processing axis direction depending on the processability determination outputted by the inference model 16 and a three-dimensional shape rotation unit 28 rotates the three-dimensional shape to the processing axis direction adjusted by the processing axis direction adjustment unit 26. However, the other components are the same as those in the first embodiment, and thus those components the same as in the first embodiment are assigned the same reference characters as in the first embodiment and detailed description thereof is omitted. Further, the hardware configuration in the second embodiment is the same as the hardware configuration in the first embodiment, and thus detailed description thereof is omitted. However, in the second embodiment, the processor 210 functions as the three-dimensional shape extraction unit 10, the three-dimensional shape rotation unit 28, the depth map transformation unit 14 and the inference model 16, while also functioning as the processing axis direction adjustment unit 26.

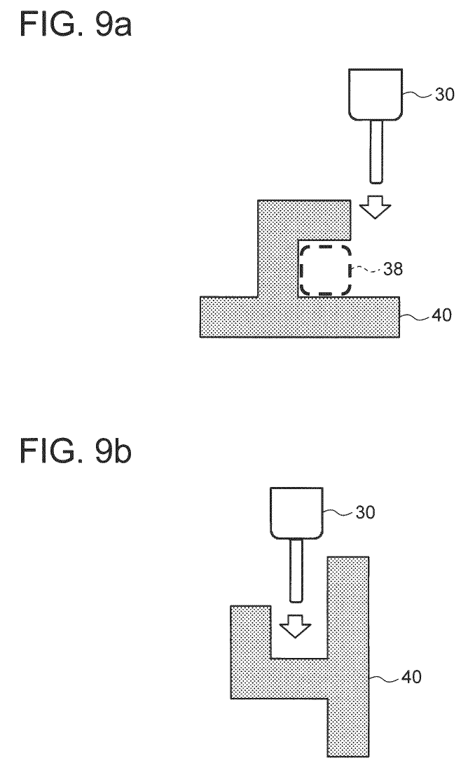

In the first embodiment, the determination on the processability is made by placing the processing axis on the Z-axis. However, at the time of determining the processability, there can exist a part where cutting is difficult in the present processing axis direction, such as an undercut shape 38 shown in FIG. 9a. Even in the case shown in FIG. 9a, the processing becomes possible depending on the processing axis direction as shown in FIG. 9b. In the second embodiment, when design data is provided, the verification is conducted in regard to every processing axis direction by repeating the processability determination while automatically changing the processing axis direction (the direction of the material 40). For example, as shown in FIG. 8, the processing axis direction is changed by rotating the material 40 in a vertical direction 50 or a horizontal direction 52. In part of cutting processing machines, there exist some types of machines capable of changing the processing axis in a state in which the material 40 is fixed; however, even in such types of machines, the control of the processing can be carried out easily and quickly by changing the processing surface by rotating the material 40, rather than by changing the processing axis. In the second embodiment and a fifth embodiment described later, the actual processing axis where the tool has been set is fixed in the Z-axis direction, for example, and the three-dimensional shape is rotated so that the processing surface becomes the same as the processing surface in the case where the processing axis is changed from the Z-axis.

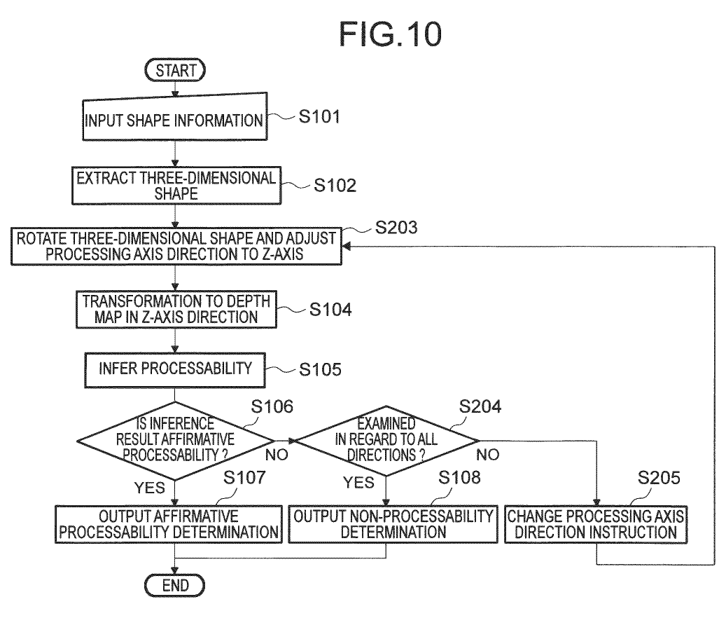

FIG. 10 is a flowchart showing an example of the determination process of the trained processability determination device 120 according to the second embodiment. The flowchart shown in FIG. 10 differs from the flowchart in the first embodiment shown in FIG. 5 in including step S203 instead of the step S103 in the first embodiment and including step S204 of determining whether the change of the processing axis direction has been made in regard to all directions or not and step S205 of changing the processing axis direction instruction. However, the other steps are the same as those in the first embodiment, and thus those steps the same as in the first embodiment are assigned the same reference characters as in the first embodiment and detailed description thereof is omitted.

In the step S203, the three-dimensional shape rotation unit 28 rotates the three-dimensional shape extracted in the step S102 according to the processing axis direction instruction. In the second embodiment, in the first determination process, the processing axis direction instruction is previously set at the Z-axis. The processing axis direction instruction may be inputted at the stage of the step S101. As will be described later, in the second embodiment, when the result of the determination indicates that the processing is not possible with the present processing axis direction instruction, the processing axis direction adjustment unit 26 changes the processing axis direction instruction, and in the step S203, the three-dimensional shape is rotated according to the processing axis direction instruction after the change.

When the result of the determination in the step S106 indicates that processing is not possible (when the result of the determination is the non-processability), the processing axis direction adjustment unit 26 in the step S204 determines whether the processability has been examined in regard to all processing axis directions or not. When the material 40 is regarded as a rectangular solid, there are six ways of processing axis direction instructions in total. Among these six ways of processing axis direction instructions, the processing axis direction adjustment unit 26 registers the Z-axis that was set in the first determination and the processing axis direction instruction changed in the later step S205 in the storage device 220. The processing axis direction adjustment unit 26 in the step S204 determines whether the processability has been examined in regard to all of the processing axis directions or not by referring to the storage device 220.

When it is determined in the step S204 that the processability has been examined in regard to all of the processing axis directions, the process is advanced to the step S108. In the step S108, the non-processability determination is outputted to the output device 310 and the process is ended similarly to the first embodiment.

When it is determined in the step S204 that the processability has not been examined in regard to all of the processing axis directions, the process is advanced to the step S205. In the step S205, the processing axis direction adjustment unit 26 changes the processing axis direction instruction and inputs the changed processing axis direction instruction to the three-dimensional shape rotation unit 28.

In the step S203, the three-dimensional shape is rotated according to the changed processing axis direction instruction. Specifically, the three-dimensional shape is rotated so that the new processing surface when the three-dimensional shape is processed in the processing axis direction indicated by the processing axis direction instruction inputted from the processing axis direction adjustment unit 26 directly faces a desired processing axis direction (the Z-axis direction in the second embodiment). In the subsequent steps, the depth map transformation unit 14 generates a new depth map by orthographically projecting the new processing surface onto a plane orthogonal to the Z-axis direction, and the inference model 16 determines the propriety of the processing of the processing plan shape by using the new depth map. When the result of the determination in the step S106 indicates that the processing is possible, the affirmative processability determination is outputted to the output device 310 in the step S107 and the process is ended.

As described above, in the second embodiment, when the design data is provided, the verification is conducted in regard to every processing axis direction by repeating the processability determination while automatically changing the processing axis direction. Consequently, even when the material has a shape for which the processability changes depending on the processing axis direction, it is possible to determine whether or not a component shape represented by the design data is non-processable in what angle since the processability determination device is configured to make the determination in regard to all of the processing axis directions. Further, in the second embodiment, it is also possible to determine the processability for the shapes of the side and back surfaces for which information is lost at the time of transforming the three-dimensional shape to the depth map.

### Third Embodiment

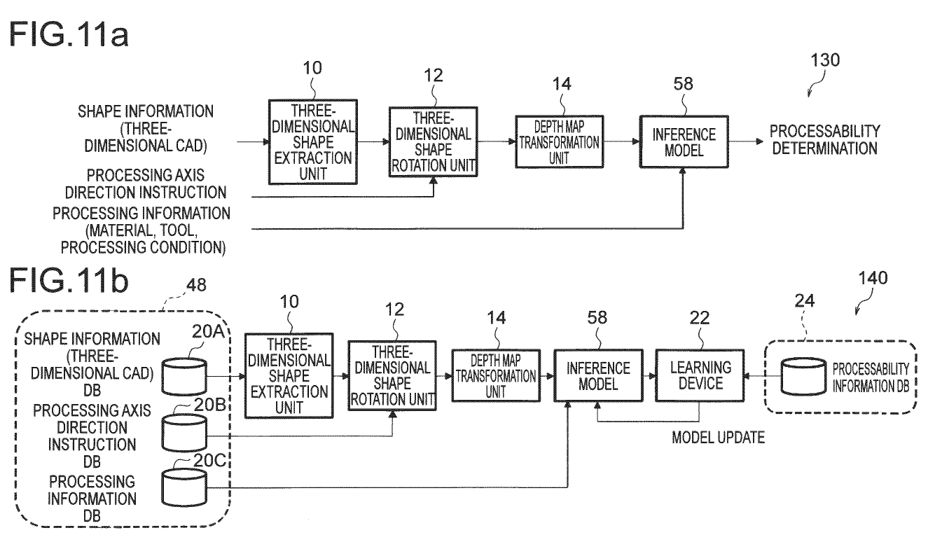

Next, a processability determination device 130 and a processability learning device 140 according to a third embodiment will be described below. The processability learning device 140 according to the third embodiment shown in FIG. 11b differs from the device in the first embodiment in that the learning device 22 updates an inference model 58 by evaluating the inference model 58 by comparing the result of judging the depth map obtained by using each of the three-dimensional CAD data and the processing axis direction instructions as the past processing case example data, the processing axis direction indicated by the processing axis direction instruction, and information on properties of the material 40, tool information (tool type, tool material, tool diameter, tool length, etc.) and a cutting parameter (feed rate of the tool, rotation speed of the tool, etc.) stored in a processing information DB 20C included in a shape-processing axis direction-processing information DB 48 by using the inference model 58 with the processability information stored in the processability information DB 24. Further, the processability determination device 130 according to the third embodiment shown in FIG. 11a differs from the device in the first embodiment in that the trained inference model 58 determines the depth map obtained by using each of the three-dimensional CAD data and the processing axis direction instructions, the processing axis direction indicated by the processing axis direction instruction, and the processing information including the information on the properties of the material 40, the tool information and the cutting parameter. However, the other components are the same as those in the first embodiment, and thus those components the same as in the first embodiment are assigned the same reference characters as in the first embodiment and detailed description thereof is omitted. Further, the hardware configuration in the third embodiment is the same as the hardware configuration in the first embodiment, and thus detailed description thereof is omitted.

Each of the properties of the material 40, the tool information and the cutting parameter greatly influences the determination on the processability. For example, when an appropriate tool is not used for a difficult-to-cut material such as stainless steel or when feed rate of the tool with respect to the difficult-to-cut material or rotation speed of the tool is inappropriate, there is a risk that the cutting surface 44 cannot be cut correctly due to vibrations of the tool 32 or the like as shown in FIG. 4c or there is a risk that the tool 34 bends and the material 40 cannot be cut correctly as shown in FIG. 4d.

As above, even when the design data is the same, the propriety of the cutting processing changes depending on the information on the properties of the material 40, the tool information and the cutting parameter. In the processability determination device 130 and the processability learning device 140 according to the third embodiment, the processability determination is made by adding at least one piece of information among the information on the properties of the material 40, the tool information and the cutting parameter to the input to the inference model 58.

As described above, according to the third embodiment, correct possibility determination can be made even when the processability changes depending on not only the design data but also the properties of the material 40, the tool and the cutting parameter.

### Fourth Embodiment

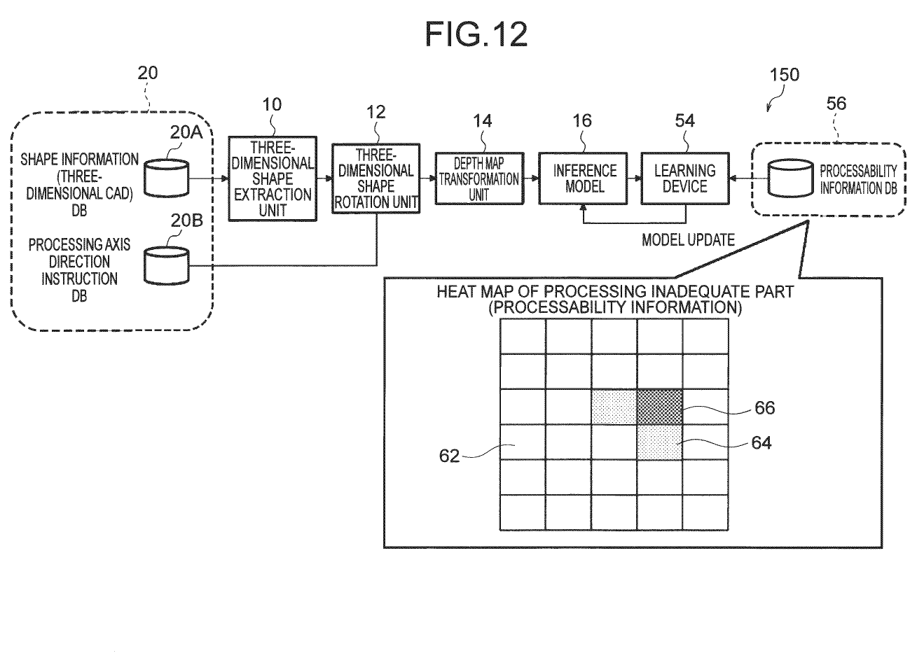

Next, a processability learning device 150 according to a fourth embodiment will be described below. The processability learning device 150 according to the fourth embodiment shown in FIG. 12 differs from the device in the first embodiment in that a heat map representing a processing inadequate part is stored in a processability information DB 56 and a learning device 54 makes model update of the inference model 16 by using the heat map as training data. However, the other components are the same as those in the first embodiment, and thus those components the same as in the first embodiment are assigned the same reference characters as in the first embodiment and detailed description thereof is omitted. Further, a processability determination device constructed by the processability learning device 150 is configured in the same way as the processability determination device 100 according to the first embodiment except in that the inference model 16 outputs a result of the determination identifying the processing inadequate part by means of learning for updating the inference model 16 by using the heat map representing the processing inadequate part as the processability information, and thus detailed description thereof is omitted. Further, the hardware configuration in the fourth embodiment is the same as the hardware configuration in the first embodiment, and thus detailed description thereof is omitted.

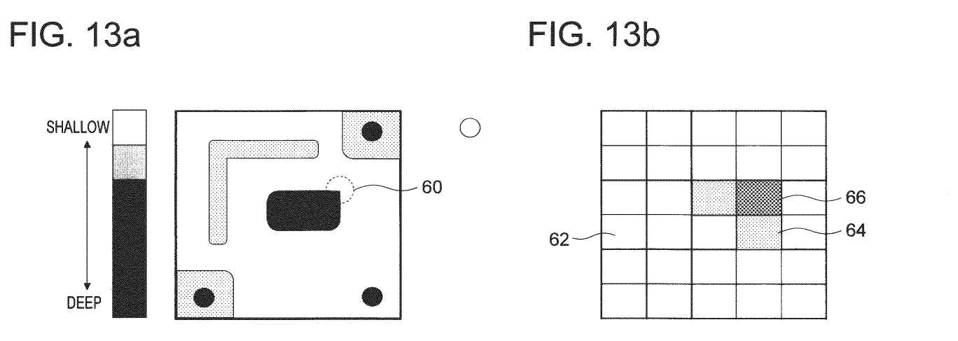

FIG. 13a is a schematic diagram showing an example of the depth map, and FIG. 13b is a schematic diagram showing an example of the heat map showing the processing inadequate part as the processability information corresponding to the depth map in FIG. 13a.

In the depth map shown in FIG. 13a, a sharp edge 60 as a so-called pin corner is described at a place corresponding to a recess. In the cutting processing, the recess is machined with a tool such as an end mill, and since the tool such as an end mill cuts the recess while rotating, a corner formed by cutting the material 40 inevitably becomes rounded and it is impossible to reproduce a pin corner like the edge 60.

In the fourth embodiment, the heat map corresponding to the depth map is used as as training data for training the inference model 16. The heat map is a map in which a range corresponding to the depth map like FIG. 13a is divided like a grid at a prescribed cell size and a numerical value representing the possibility of the processing is associated with each cell. For example, in FIG. 13b, each cell expressed with white color is a processable part 62 with which a numerical value close to 0 has been associated, and the cell expressed with black color is a non-processable part 66 with which a numerical value close to 1 has been associated. Then, in FIG. 13b, each cell expressed with gray is an intermediate part 64 having slight difficulty in the processing with which a numerical value between 0 and 1 has been associated. The numerical value associated with each cell of the heat map being the processability information is determined based on the result of actually manually verifying whether the machining is possible or not.

In the fourth embodiment, the learning device 54 evaluates the inference model 16 by comparing the result of judging the depth map, obtained by using each of the three-dimensional CAD data and the processing axis direction instructions as the past processing case example data, by using the inference model 16 with the heat map as the processability information corresponding to the three-dimensional CAD data and the processing axis direction instruction used by the inference model 16 for the judgment, and updates the inference model 16.

The processability determination device constructed by the above-described learning outputs the heat map, in which the level of the processing inadequate part has been digitized to a numerical value in regard to each cell, as the result of the determination of the processability. Consequently, according to the fourth embodiment, it is possible to precisely indicate what part in the three-dimensional shape or the depth map is the processing inadequate part.

### Fifth Embodiment

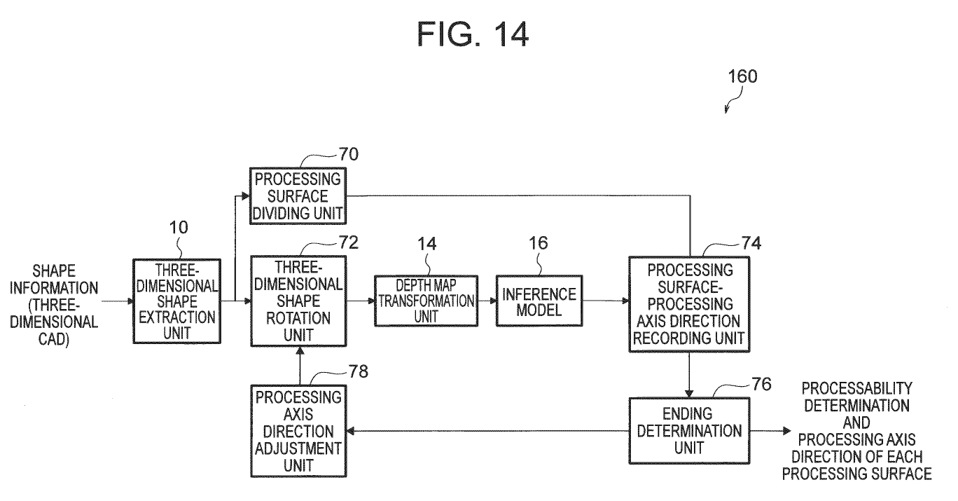

Next, a processability determination device 160 according to a fifth embodiment will be described below. The processability determination device 160 according to the fifth embodiment shown in FIG. 14 differs from the device in the first embodiment in that the processability determination device 160 includes a processing surface dividing unit 70 that generates a processing surface list by listing all processing surfaces of the material 40 from the three-dimensional shape extracted by the three-dimensional shape extraction unit 10, a processing surface-processing axis direction recording unit 74 that receives an input of the processing surface list generated by the processing surface dividing unit 70 and records the processing axis direction of each processing surface judged to be processable in the processability determination outputted by the inference model 16 in the processing surface list, an ending determination unit 76 that makes an ending determination when the affirmative processability determination has been made for all processing surfaces described in the processing surface list or when the processability in all of the processing axis directions has already been verified and outputs the processability determination regarding the three-dimensional shape and the processing axis direction of each processing surface, and a processing axis direction adjustment unit 78 that outputs an instruction of processing axis directions other than the processing axis directions for which the processability has already been verified when the ending determination unit 76 determines that not all of the processing axis directions have been verified, and a three-dimensional shape rotation unit 72 rotates the three-dimensional shape to the processing axis direction adjusted by the processing axis direction adjustment unit 78. However, the other components are the same as those in the first embodiment, and thus those components the same as in the first embodiment are assigned the same reference characters as in the first embodiment and detailed description thereof is omitted. Further, the hardware configuration in the fifth embodiment is the same as the hardware configuration in the first embodiment, and thus detailed description thereof is omitted. However, in the fifth embodiment, the processor 210 functions as the three-dimensional shape extraction unit 10, the three-dimensional shape rotation unit 72, the depth map transformation unit 14 and the inference model 16, while also functioning as the processing surface dividing unit 70, the processing surface-processing axis direction recording unit 74, the ending determination unit 76 and the processing axis direction adjustment unit 78.

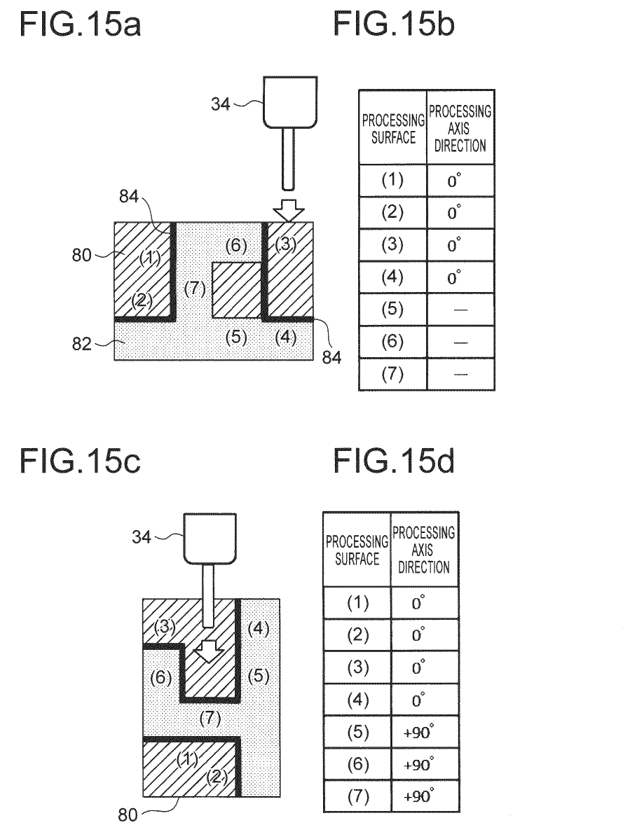

FIG. 15a is an explanatory diagram showing a processing plan shape 82 for a material shape 80. Processing surfaces (1), (2), (3), (4), (5), (6) and (7) have been set in regard to the processing plan shape 82; however, in the state shown in FIG. 15a, surfaces processable with the tool 34 are processable surfaces 84 and the processing surfaces (5), (6) and (7) are not processable.

FIG. 15b is an explanatory diagram of a case where the processing surface-processing axis direction recording unit 74 has recorded the processing axis directions in the processing surface list generated by the processing surface dividing unit 70. In the case shown in FIG. 15a, the processing of the processing surfaces (1) to (4) is possible, and thus 0° representing the Z-axis direction, for example, is described as their processing axis directions in the processing surface list. However, in the case shown in FIG. 15a, the processing of the processing surfaces (5) to (7) is impossible, and thus their processing axis directions in the processing surface list are blank.

FIG. 15c is an explanatory diagram of a case where the material shape 80 shown in FIG. 15a is rotated 90° to the left in the drawing by the three-dimensional shape rotation unit 72. By the 90° rotation of the material shape 80, the processing of the processing surfaces (5) to (7), having been impossible before the rotation, becomes possible.

FIG. 15d is an explanatory diagram of a case where the processing surface-processing axis direction recording unit 74 has recorded the processing axis directions in the processing surface list in the state after the 90° rotation of the material shape 80. As shown in FIG. 15c, in the state after the 90° rotation of the material shape 80, the processing of the processing surfaces (5) to (7) is possible, and thus +90° as the rotation angle with respect to the Z-axis is described as their processing axis directions in the processing surface list.

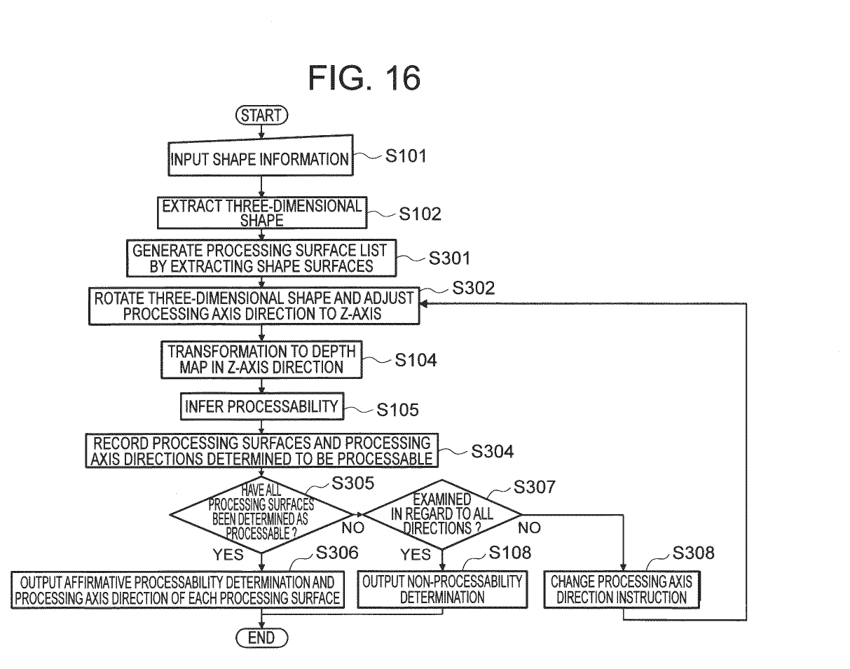

FIG. 16 is a flowchart showing an example of the determination process of the trained processability determination device 160 according to the fifth embodiment. The flowchart shown in FIG. 16 differs from the flowchart in the first embodiment shown in FIG. 5 in including step S302 instead of the step S103 in the first embodiment and in including step S301 of generating the processing surface list by extracting the processing surfaces from the three-dimensional shape extracted by the three-dimensional shape extraction unit 10, step S304 in which the processing surface-processing axis direction recording unit 74 records the processing surfaces and the processing axis directions determined to be processable in the processing surface list, step S305 in which the ending determination unit 76 judges whether or not all of the processing surfaces have been determined to be processable, step S306 of outputting the affirmative processability determination and the processing axis direction of each processing surface, step S307 of judging whether or not the change of the processing axis direction has been made for all the directions, and step S308 of changing the processing axis direction instruction. However, the other steps are the same as those in the first embodiment, and thus those steps the same as in the first embodiment are assigned the same reference characters as in the first embodiment and detailed description thereof is omitted.

In the step S301, the processing surface dividing unit 70 generates a processing surface list shown in FIG. 15b or FIG. 15d by extracting the processing surfaces from the three-dimensional shape extracted by the three-dimensional shape extraction unit 10 in the step S102.

In the step S302, the three-dimensional shape rotation unit 72 rotates the three-dimensional shape extracted in the step S102 according to the processing axis direction instruction. In the fifth embodiment, in the first determination process, the processing axis direction instruction is previously set at the Z-axis. The processing axis direction instruction may be inputted at the stage of the step S101. As will be described later, in the fifth embodiment, when the result of the determination is not the affirmative processability with the present processing axis direction instruction, the processing axis direction adjustment unit 78 changes the processing axis direction instruction, and in the step S302, the three-dimensional shape is rotated according to the processing axis direction instruction after the change.

In the step S304, the processing surface-processing axis direction recording unit 74 records the processing surfaces and the processing axis directions determined to be processable in the processing surface list based on the processability determination outputted by the inference model 16 in the step S105.

In the step S305, the ending determination unit 76 judges whether or not all of the processing surfaces have been determined to be processable. The ending determination unit 76 judges that all of the processing surfaces have been determined to be processable if all fields in the processing axis direction column of the processing surface list have been filled with information on a significant angle such as 0° or +90° as shown in FIG. 15d, for example. In the step S305, the process is advanced to the step S306 when it is judged that all of the processing surfaces have been determined to be processable, or the process is advanced to the step S307 when it is judged that not all of the processing surfaces have been determined to be processable.

In the step S306, the final affirmative processability determination regarding the three-dimensional shape and the processing axis direction of each processing surface are outputted to the output device 310, and the process is ended. The information on the affirmative processability determination and the processing axis direction of each processing surface outputted in the step S306 is, for example, the processing surface list shown in FIG. 15d in which the processing axis direction corresponding to each processing surface is described.

When it is judged in the step S305 that not all of the processing surfaces have been determined to be processable, the ending determination unit 76 in the step S307 judges whether or not the change of the processing axis direction has been made for all the directions. When the material 40 is regarded as a rectangular solid, there are six ways of processing axis direction instructions in total. Similarly to the second embodiment, among these six ways of processing axis direction instructions, the processing axis direction adjustment unit 78 registers the Z-axis that was set in the first determination and the processing axis direction instruction changed in the later step S308 in the storage device 220. In the step S307, the ending determination unit 76 judges whether the processability has been examined in regard to all the processing axis directions or not by referring to the storage device 220. Alternatively, it is also possible to provide the processing surface list specially with a column of processing axis change history and make the ending determination unit 76 judge whether the processability has been examined in regard to all the processing axis directions or not by referring to the column.

When it is judged in the step S307 that the change of the processing axis direction has been made for all the directions, the process is advanced to the step S108. In the step S108, the non-processability determination is outputted to the output device 310 and the process is ended similarly to the first embodiment.

When it is judged in the step S307 that the change of the processing axis direction has not been made for all the directions, the process is advanced to the step S308. In the step S308, the processing axis direction adjustment unit 78 changes the processing axis direction instruction and inputs the changed processing axis direction instruction to the three-dimensional shape rotation unit 72.

In the step S302, the three-dimensional shape rotation unit 72 rotates the three-dimensional shape according to the changed processing axis direction instruction. In the subsequent steps, the transformation of the depth map and the inference of the processability are performed, and when all the processing surfaces are determined to be processable in the step S305, the processability determination and the processing axis direction of each processing surface are outputted to the output device 310 in the step S306, and the process is ended.

As described above, according to the fifth embodiment, similarly to the second embodiment, even when the material has a shape with processability that changes depending on the processing axis direction, it is possible to determine whether or not the component shape represented by the design data is non-processable in what angle since the processability determination device is configured to make the determination in regard to all of the processing axis directions. Further, by not only clarifying the processability but also clarifying from which direction each processing surface is processable, a setup process at the time of the actual processing can be facilitated.

Incidentally, an inference unit in the claims corresponds to the inference model 16 or 58 described in the detailed description of the invention.

### DESCRIPTION OF REFERENCE CHARACTERS

10: three-dimensional shape extraction unit, 12: three-dimensional shape rotation unit, 14: depth map transformation unit, 16: inference model, 20A: shape information DB, 20B: processing axis direction instruction DB, 20C: processing information DB, 22: learning device, 24: processability information DB, 26: processing axis direction adjustment unit, 30, 32, 34: tool, 40: material, 54: learning device, 56: processability information DB, 58: inference model, 70: processing surface dividing unit, 72: three-dimensional shape rotation unit, 74: processing surface-processing axis direction recording unit, 76: ending determination unit, 78: processing axis direction adjustment unit, 100: processability determination device, 110: processability learning device, 120: processability determination device, 130: processability determination device, 140: processability learning device, 150: processability learning device, 160: processability determination device.

What is claimed is:

1. A processability determination device comprising:
processing circuitry
to extract a three-dimensional shape from three-dimensional shape data representing a processing plan shape;
to rotate the three-dimensional shape so that a processing surface in the three-dimensional shape faces a desired processing axis direction; and
to generate a depth map in which information on depth in the desired processing axis direction extracted from the three-dimensional shape data is attached to a two-dimensional image obtained by orthographically projecting the processing surface onto a plane orthogonal to the desired processing axis direction; and
an inference model that is constructed by machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the generated depth map.

2. The processability determination device according to claim 1, wherein
the processing circuitry
outputs an instruction of a processing axis direction different from the desired processing axis direction when the inference model outputs a non-processability determination in the inference regarding the processing surface facing the desired processing axis direction,
rotates the three-dimensional shape so that a new processing surface when the three-dimensional shape is processed in the processing axis direction indicated by the inputted processing axis direction instruction faces the desired processing axis direction, and
generates a new depth map by orthographically projecting the new processing surface onto a plane orthogonal to the desired processing axis direction, and
the inference model determines the propriety of the processing of the processing plan shape by using the new depth map.

3. The processability determination device according to claim 1, wherein the inference model is constructed by machine learning by use of the learning processing axis direction instruction, the learning depth map extracted from the learning three-dimensional shape data according to the learning processing axis direction instruction, learning processing information made up of tool information including a tool type, a tool material, a tool diameter and a tool length, information on material of a processing object, and a cutting parameter including feed rate of a tool and rotation speed of the tool, and processability information describing the propriety of actual processing already performed according to the learning processing axis direction instruction, the learning three-dimensional shape data and the learning processing information, and determines the propriety of the processing of the processing plan shape by inference by use of the desired processing axis direction, the generated depth map, and newly inputted processing information made up of the tool information including the tool type, the tool material, the tool diameter and the tool length, the information on the material of the processing object, and the cutting parameter including the feed rate of the tool and the rotation speed of the tool.

4. The processability determination device according to claim 1, wherein
the processability information is a heat map representing a processing inadequate part on the processing surface, and
the inference model is constructed by machine learning by use of the learning processing axis direction instruction, the learning depth map extracted from the learning three-dimensional shape data according to the learning processing axis direction instruction, and the heat map describing the propriety of actual processing already performed according to the learning processing axis direction instruction and the learning three-dimensional shape data, and outputs a result of the determination identifying the processing inadequate part in the processing plan shape by inference by use of the desired processing axis direction and the generated depth map.

5. The processability determination device according to claim 1, wherein
the processing circuitry
generates a processing surface list by listing all processing surfaces of a processing object from the extracted three-dimensional shape;
records the processing axis direction of each processing surface judged to be processable in a processability determination outputted by the inference model in the processing surface list;
makes an ending determination when an affirmative processability determination has been made for all processing surfaces described in the processing surface list or when the processability in all processing axis directions has already been verified and outputs the processability determination regarding the three-dimensional shape and the processing axis direction of each processing surface;
outputs an instruction of processing axis directions other than the processing axis directions for which the processability has already been verified when the processing circuitry judges that the processability in all of the processing axis directions has not been verified;
rotates the three-dimensional shape so that a new processing surface when the three-dimensional shape is processed in the processing axis direction indicated by the inputted processing axis direction instruction faces the desired processing axis direction; and
generates a new depth map by orthographically projecting the new processing surface onto a plane orthogonal to the desired processing axis direction, and
the inference model determines the propriety of the processing of the processing plan shape by using the new depth map.

6. A processability learning device comprising:
processing circuitry
to extract a learning three-dimensional shape from inputted learning three-dimensional shape data;
to rotate the three-dimensional shape so that a processing surface in the three-dimensional shape faces a learning processing axis direction indicated by an inputted learning processing axis direction instruction; and
to generate a learning depth map in which information on depth in the learning processing axis direction extracted from the learning three-dimensional shape data is attached to a two-dimensional image obtained by orthographically projecting the processing surface onto a plane orthogonal to the learning processing axis direction; and
an inference model that is updated by a learning device that performs machine learning by use of the learning processing axis direction instruction, the learning depth map, and processability information describing propriety of actual processing already performed according to the learning processing axis direction instruction and the learning three-dimensional shape data,
wherein the processability learning device constructs the processability determination device according to claim 1 by the machine learning.

7. A processability learning device comprising:
processing circuitry
to extract a learning three-dimensional shape from inputted learning three-dimensional shape data;
to rotate the three-dimensional shape so that a processing surface in the three-dimensional shape faces a learning processing axis direction indicated by an inputted learning processing axis direction instruction; and
to generate a learning depth map in which information on depth in the learning processing axis direction extracted from the learning three-dimensional shape data is attached to a two-dimensional image obtained by orthographically projecting the processing surface onto a plane orthogonal to the learning processing axis direction; and
an inference model that is updated by a learning device that performs machine learning by use of the learning processing axis direction instruction, the learning depth map, and learning processing information made up of tool information including a tool type, a tool material, a tool diameter and a tool length, information on material of a processing object, and a cutting parameter including feed rate of a tool and rotation speed of the tool, and processability information describing propriety of actual processing already performed according to the learning processing axis direction instruction, the learning three-dimensional shape data and the learning processing information,
wherein the processability learning device constructs the processability determination device according to claim 3 by the machine learning.

8. A processability learning device comprising:
processing circuitry
to extract a learning three-dimensional shape from inputted learning three-dimensional shape data;
to rotate the three-dimensional shape so that a processing surface in the three-dimensional shape faces a learning processing axis direction indicated by an inputted learning processing axis direction instruction; and
to generate a learning depth map in which information on depth in the learning processing axis direction extracted from the learning three-dimensional shape data is attached to a two-dimensional image obtained by orthographically projecting the processing surface onto a plane orthogonal to the learning processing axis direction; and
an inference model that is updated by a learning device that performs machine learning by use of the learning processing axis direction instruction, the learning depth map, and a heat map representing a processing inadequate part in actual processing already performed according to the learning processing axis direction instruction and the learning three-dimensional shape data,
wherein the processability learning device constructs the processability determination device according to claim 4 by the machine learning.

9. A processability determination method to be executed by a computer, comprising:
extracting a three-dimensional shape from three-dimensional shape data representing a processing plan shape;
rotating the three-dimensional shape so that a processing surface in the three-dimensional shape faces a desired processing axis direction;
generating a depth map in which information on depth in the desired processing axis direction extracted from the three-dimensional shape data is attached to a two-dimensional image obtained by orthographically projecting the processing surface onto a plane orthogonal to the desired processing axis direction; and
performing machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the depth map.

10. A non-transitory computer-readable storage medium storing a processability determination program that causes a computer to execute:
extracting a three-dimensional shape from three-dimensional shape data representing a processing plan shape;
rotating the three-dimensional shape so that a processing surface in the three-dimensional shape faces a desired processing axis direction;
generating a depth map in which information on depth in the desired processing axis direction extracted from the three-dimensional shape data is attached to a two-dimensional image obtained by orthographically projecting the processing surface onto a plane orthogonal to the desired processing axis direction; and
performing machine learning by use of a learning processing axis direction instruction, a learning depth map extracted from learning three-dimensional shape data according to the learning processing axis direction instruction, and processability information describing propriety of actual processing already performed according to the learning processing axis direction instruction and the learning three-dimensional shape data, and determines the propriety of processing of the processing plan shape by inference by use of the desired processing axis direction and the depth map.

11. A processability learning method to be executed by a computer, comprising:
extracting a learning three-dimensional shape from inputted learning three-dimensional shape data;
rotating the three-dimensional shape so that a processing surface in the three-dimensional shape faces a learning processing axis direction indicated by an inputted learning processing axis direction instruction;
generating a learning depth map in which information on depth in the learning processing axis direction extracted from the learning three-dimensional shape data is attached to a two-dimensional image obtained by orthographically projecting the processing surface onto a plane orthogonal to the learning processing axis direction; and
updating an inference model, which determines propriety of processing of a processing plan shape, with a learning device that performs machine learning by use of the learning processing axis direction instruction, the learning depth map, and processability information describing the propriety of actual processing already performed according to the learning processing axis direction instruction and the learning three-dimensional shape data,
wherein the processability learning method constructs the processability determination device according to claim 1 by the machine learning.

12. A non-transitory computer-readable storage medium storing a processability learning program that constructs the processability determination device according to claim 1 by causing a computer to execute:
extracting a learning three-dimensional shape from inputted learning three-dimensional shape data;
rotating the three-dimensional shape so that a processing surface in the three-dimensional shape faces a learning processing axis direction indicated by an inputted learning processing axis direction instruction;
generating a learning depth map in which information on depth in the learning processing axis direction extracted from the learning three-dimensional shape data is attached to a two-dimensional image obtained by orthographically projecting the processing surface onto a plane orthogonal to the learning processing axis direction; and
updating an inference model, which determines propriety of processing of a processing plan shape, with a learning device that performs machine learning by use of the learning processing axis direction instruction, the learning depth map, and processability information describing the propriety of actual processing already performed according to the learning processing axis direction instruction and the learning three-dimensional shape data.
